(19) United States
(12) Patent Application Publication
(10) Pub. No.: US 2022/0225751 A1
(43) Pub. Date: Jul. 21, 2022

(54) Cosmetic Massage and Liquid Distributing Neck and Facial Mask Electronic Device or Electronic Cosmetic Apparatus

(71) Applicants: Shamikia Gottlieb, Charlotte, NC (US); Gerard David Gottlieb, JR., Charlotte, NC (US)

(72) Inventors: Shamikia Gottlieb, Charlotte, NC (US); Gerard David Gottlieb, JR., Charlotte, NC (US)

(21) Appl. No.: 17/154,774

(22) Filed: Jan. 21, 2021

(51) Int. Cl. A45D 44/00; A45D 34/04; A61H 15/00

(52) U.S. Cl. CPC A45D 44/002; A45D 34/04; A61H 15/00; A61H 2201/165; A61H 2205/022; A61H 2205/04; A61H 2201/105; A61H 2015/005

(57) ABSTRACT

The present invention is a cosmetic massage and liquid distributing electronic mask or electronic cosmetic apparatus utilized for skin health. The present invention presents a unique way for users to engage in a hands-free massage in conjunction with cosmetic skincare products to maintain healthy skin appearance. The said cosmetic apparatus lifts and firms the skin, and increases collagen production to areas of the face and neck to renew the skin.

### CROSS-REFERENCE TO RELATED APPLICATIONS

Application No. 63/060,794

Filing Date: Aug. 4, 2020

### FIELD OF INVENTION

The invention relates to cosmetic devices or cosmetic apparatuses, more particularly, electrical massaging cosmetic devices pertaining to skin health.

### BACKGROUND OF THE INVENTION

Prior art denotes the use of massaging cosmetic devices in the use of skin health. Skin is the largest organ of the human body, and like any other organ, it requires care. Prolonged exposure to environmental toxins, ultraviolet rays, lack of moisture, and dehydration, contribute to the lack of luster and damaged appearance of the skin. Even more, the face and neck regions of the body are more susceptible to damage due to lower skin density compared to other sites on the body. Further, as one begins to age, skin tends to sag and wrinkle and become cracked or dry. The present invention provides a benefit to the user by performing a massage to stimulate the face and neck regions to increase blood flow to these areas that allows the skin to repair itself, thus improving overall skin health by reversing the signs of aging. With repeated use of the present invention, leads to refinement in skin tone, texture and firmness.

### BRIEF SUMMARY OF INVENTION

An electronic cosmetic apparatus or cosmetic massage and liquid distributing electronic mask, comprising, massaging rubber rotating balls and a fluid dispenser or pump attachment allow cosmetic product distribution to the face and neck and an increase in blood flow to the facial and neck regions, aiding in collagen production to minimize the signs of aging, as in wrinkles and sagging skin. The object of the present invention is to provide users with a hands-free massage, in tandem with specified cosmetic products for the purpose of improving their outer appearance by renewing their skin.

### DETAILED DESCRIPTION OF INVENTION

The present invention is a cosmetic massage and liquid distributing electronic mask used for the face and neck. The invention, also referred to as an electronic cosmetic apparatus, is comprised of 24 rotating balls. Cosmetic products, such as serums and essences, are inserted into a separate compartment, referred to as the fluid dispenser or pump attachment. A specified amount of cosmetic product is placed within the fluid dispenser which is then released through a tubing attachment connected to the face and neck equipment. The 24 rotating balls move in an upward direction and retract to original position to repeat action until desired massage time is completed within intervals of 10, 20, or 30 minutes. The present invention contains an adjustable elastic head band or strap to situate mask to conform to various head sizes. To maintain results, it is recommended the mask is used a few times a week. In order to combat any issue of material durability after prolonged use, the face and neck housing are made from a durable PVC material.

The embodiment of the present invention provides users with the ability to perform a hands-free massage on their face and neck while a specified amount of cosmetic product is disbursed during said massage intervals. A user will place said cosmetic apparatus on their face and neck and fit device accordingly by adjusting the elastic strap that is adhered to the back side of the face and neck equipment. Cosmetic product from said pump is distributed to the neck and face equipment. The massaging rubber rotating balls are covered in the cosmetic product and said product is transferred to the users face and neck during the set time interval. The said balls move in an upward, outward, circular or rotating motion.

The embodiment of the present invention for said fluid dispenser or pump attachment is comprised of a housing for liquid and a timer. The said pump attachment utilizes airflow pressure to pull cosmetic liquids through a tubing connection. The said liquids are then transferred from the pump attachment to the face and neck equipment. The timer is for specifying the time intervals of a massage. The time intervals for a massage are 10, 20, and 30 minutes.

The embodiment of the present invention comprises elastic straps for user comfort and adheres to the head, face, and neck of a user. The adjustable elastic straps allow the user to properly fit and align face and neck components or equipment according to their own individual head and neck shape before engaging in a massage.

The embodiment of the present invention provides usefulness to the user by improving skin health. The said invention aids in lifting or firming the skin as the balls move in a consistent, upward direction to work in opposite direction of gravitational effects and environmental conditions that diminish skin health.

The present invention should not be limited to the embodiment. Various modifications and changes may be made by those skilled in the art without deviating from the present invention, which all belong to the protection and present domain of the utility model.

### BRIEF DESCRIPTION OF DRAWINGS

FIG. 1 is a schematic diagram depicting a massaging cosmetic facial component according to one embodiment of the invention

FIG. 2 is a schematic diagram depicting a massaging cosmetic neck component according to one embodiment of the invention

FIG. 3 is a schematic diagram depicting a fluid dispenser or pump attachment according to one embodiment of the invention

FIG. 4 is a schematic diagram depicting a side view of the massaging cosmetic facial component with elastic straps according to one embodiment of the invention

FIG. 5 shows an image of a rubber ball and compartment, wherein cosmetic product of liquid form flows through and ball movement is achieved

FIG. 6 is an illustrated image of a front view of the fluid dispenser or pump attachment, tubing connection and massaging cosmetic facial component according to one embodiment of the invention

FIG. 7 shows an image depicting a front view of the outer encasement of the massaging facial component

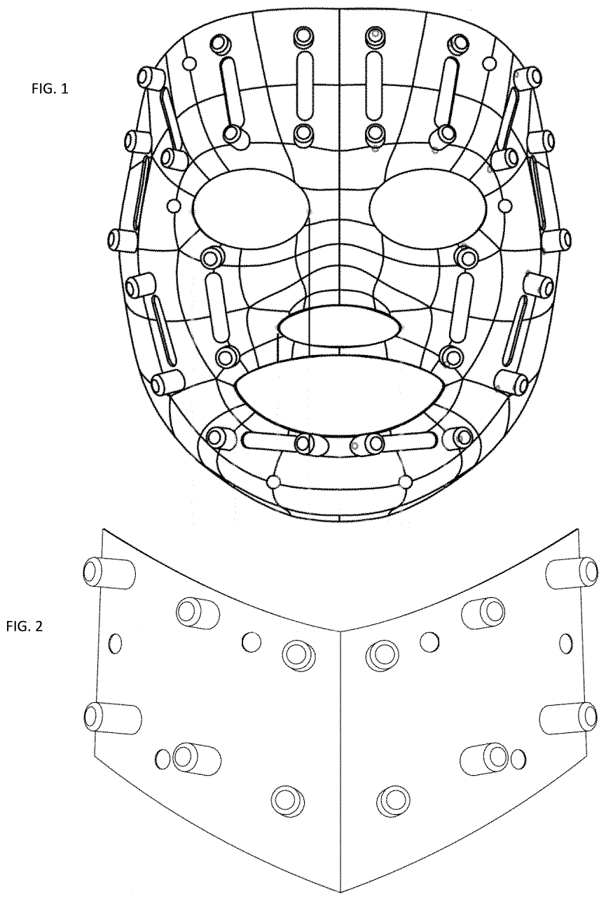

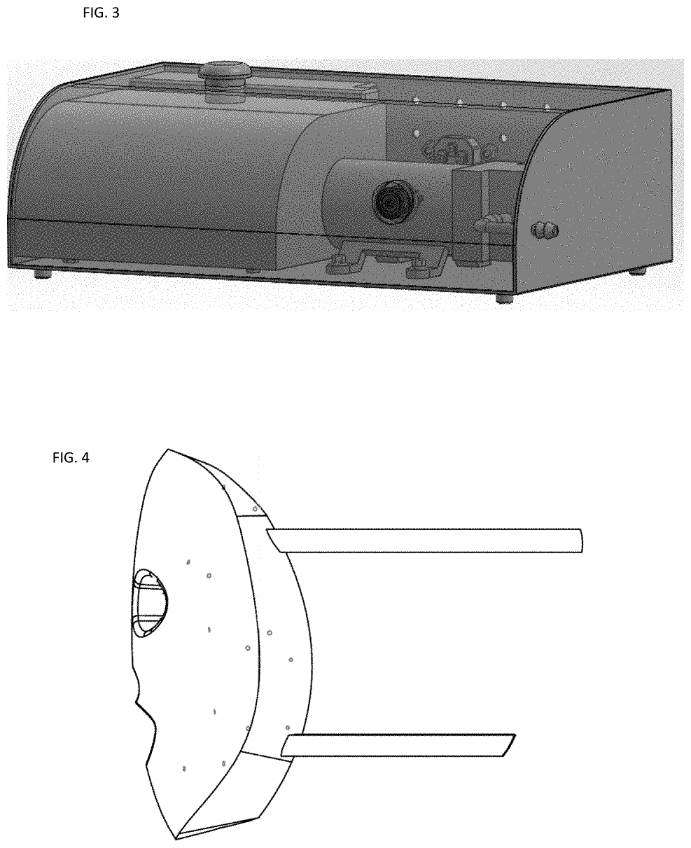

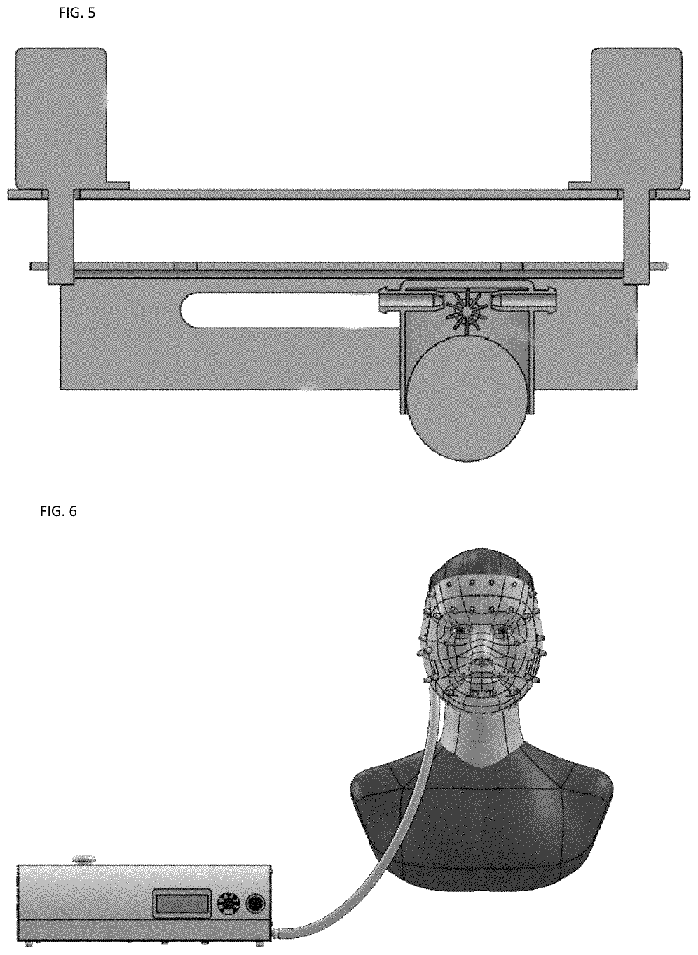

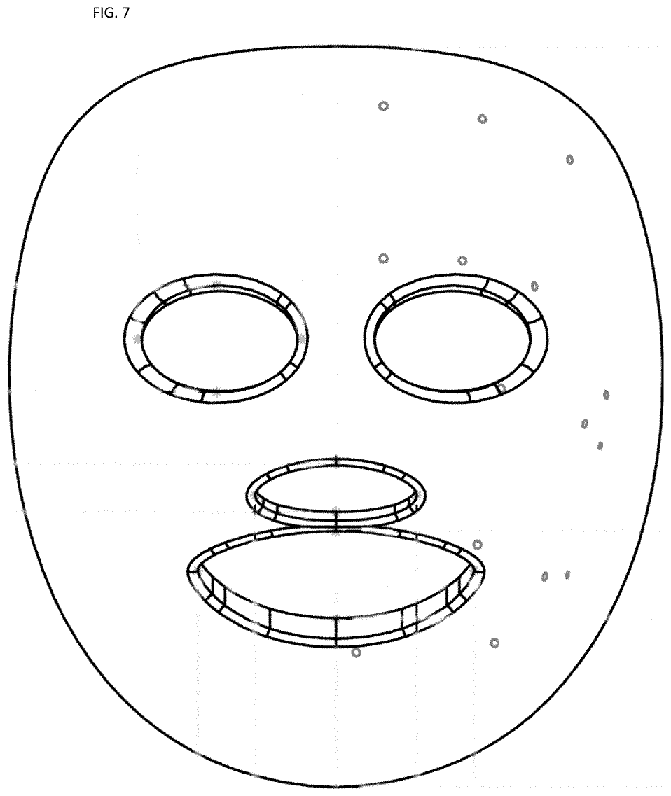

1. A cosmetic massage and liquid distributing electronic mask or electronic cosmetic apparatus by which cosmetic product is dispersed to the user's face and neck, comprising:
(a) a separate pump attachment or fluid dispenser, wherein cosmetic product of liquid form is transferred to the cosmetic apparatus
(b) rotating balls that enables a hands-free massage, wherein a set of 24 rubber balls move in an upward, outward, circular or rotating motion
(c) said pump attachment or fluid dispenser, comprising a timer and liquid housing.

2. A cosmetic massage and liquid distributing electronic mask or electronic cosmetic apparatus according to claim 1, comprising separate face and. neck components, wherein the face and neck components allows for the user face and neck to be massaged in conjunction.

3. A cosmetic massage and liquid distributing electronic mask or electronic cosmetic apparatus according to claim 1, comprising a separate pump attachment or fluid dispenser, as recited in claim 1, wherein liquid is housed and distributed by a tubing connection to the face and neck equipment.
